(19) United States
(12) Patent Application Publication
(10) Pub. No.: US 2012/0042340 A1
(43) Pub. Date: Feb. 16, 2012

(54) GUIDE DISPLAY FOR ANTENNA DIRECTION

(76) Inventor: Masafumi Naka, Irvine, CA (US)

(21) Appl. No.: 12/855,216

(22) Filed: Aug. 12, 2010

(51) Int. Cl. H04N 5/00; H04B 7/00; G05B 19/02

(52) U.S. Cl. 725/37; 342/367

(57) ABSTRACT

Improved systems and methods that facilitate orienting the direction of an antenna for viewing digital television signals from available broadcast stations. An embodiment includes an antenna directional guide displayable on a screen of a television enabling the viewer to select an antenna direction to view television signals receivable by the antenna from broadcast stations located along selected reception direction of the antenna.

### FIELD

The present invention relates generally to televisions and, more particularly, to systems and methods for altering the direction of an antenna for viewing available broadcast stations.

### BACKGROUND

Prior to the advent of broadcasting television signals via cable and satellite, terrestrial broadcasting systems broadcast television signals which were received by a viewer via an antenna. These system were analog systems which had physical channel numbers. To view the broadcast of a particular broadcast station, the viewer would change the channel selector of the television to the physical channel corresponding to the broadcast station and then adjust the antenna direction for best reception.

Terrestrial broadcasting of television signals is changing to digital. In order to receive the broadcasting signal, the viewer needs to set an antenna direction toward the broadcasting station. Since digital broadcasting systems have virtual channels, the consumer cannot select a physical channel to receive the digital broadcast signal and get virtual channel information from the broadcasting station. Instead the consumer needs to set the antenna direction first before tuning the television to the desired channel.

Therefore, it would be desirable to provide systems and methods that facilitate orienting the direction of an antenna for viewing television signals from available broadcast stations.

### SUMMARY

Embodiments described herein are directed to improved methods and systems that facilitate orienting the direction of an antenna for viewing television signals from available broadcast stations. In a preferred embodiment, an antenna directional guide is displayable to the viewer on a screen of a television to which the antenna is connected enabling the viewer to select an antenna direction to view television signals receivable by the antenna from broadcast stations located along selected reception direction of the antenna.

Other objects, systems, methods, features, and advantages of the invention will be or will become apparent to one with skill in the art upon examination of the following figures and detailed description. It is intended that all such additional systems, methods, features and advantages be included within this description, be within the scope of this invention, and be protected by the accompanying claims. It will be understood that the particular methods and apparatus are shown by way of illustration only and not as limitations. As will be understood by those skilled in the art, the principles and features explained herein may be employed in various and numerous embodiments.

### DESCRIPTION OF THE DRAWINGS

The details of the invention, both as to its structure and operation, may be gleaned in part by study of the accompanying figures, in which like reference numerals refer to like parts. The components in the figures are not necessarily to scale, emphasis instead being placed upon illustrating the principles of the invention. Moreover, all illustrations are intended to convey concepts, where relative sizes, shapes and other detailed attributes may be illustrated schematically rather than literally or precisely.

FIG. 1 is a schematic diagram of a television system.

FIG. 2 is a schematic diagram of an antenna directional guide displayable to the television viewer on the screen of the television shown in FIG. 1.

It should be noted that elements of similar structures or functions are generally represented by like reference numerals for illustrative purpose throughout the figures. It should also be noted that the figures are only intended to facilitate the description of the preferred embodiments.

### DETAILED DESCRIPTION

Embodiments described herein are directed to improved methods and systems that facilitate orientation of the direction of an antenna for viewing television signals from available broadcast stations. In a preferred embodiment, an antenna directional guide is displayable to the viewer on a screen of a television to which the antenna is connected enabling the viewer to select an antenna direction to view television signals receivable by the antenna from broadcast stations located along selected reception direction of the antenna.

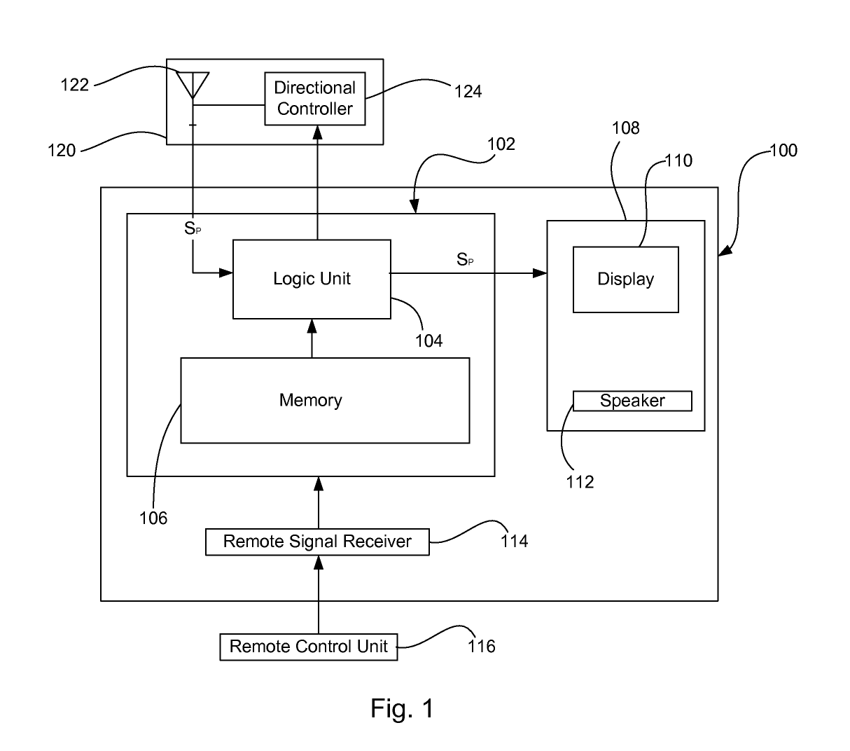

Turning to figures, the embodiments provided herein are described in detail. In an embodiment, as depicted in FIG. 1, a television system 100 adapted to enable viewing of terrestrial broadcasts of digital television program signals comprises a central processing unit (CPU) 102 coupled to an audio-video output unit 108, a remote signal receiver 114, which is operably coupled to a remote control unit 116, and an antenna unit 120. The CPU 102 preferably comprises non-volatile memory 106 coupled to a logic unit 104 which includes integrated circuits, processors, and software stored in memory 106 and executable on the processors. The logic unit 104 is configured to receive program signals Sₚ, including audio such as radio program signals and audio-video signals such as television program signals, from an antenna 122 of the antenna unit 120, and output the program signals to an audio-video output unit 108. The antenna unit 120 includes a directional controller 124 for orienting the antenna 122 to a desired receiving direction to receive digital terrestrial broadcast signals from broadcasting station along the receiving direction.

The audio-video output unit 108 preferably includes a video display 110 for displaying the images or video component of the program signal Sₚ and a speaker 112 for outputting the audio program signal Sₚ or the audio component of the program signal Sₚ associated with the video component of program signal Sₚ.

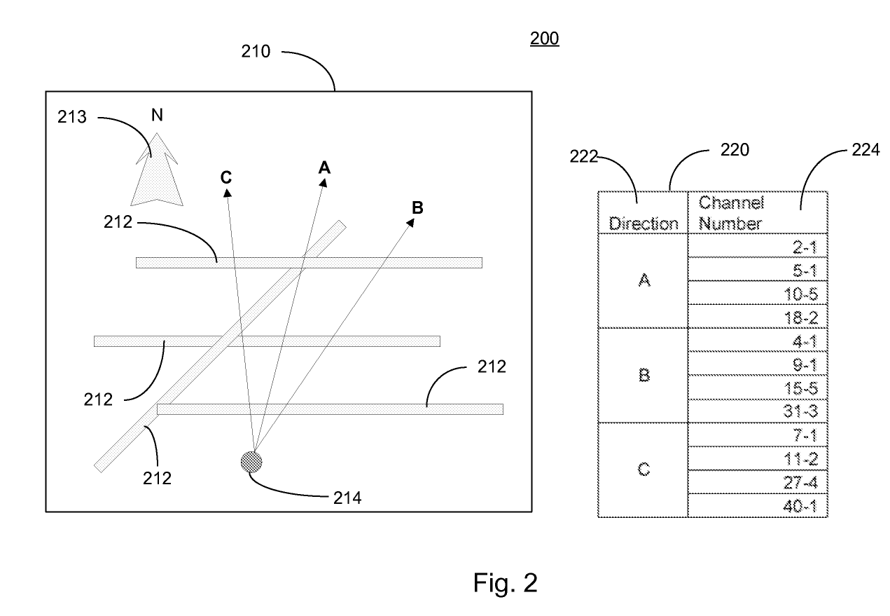

The logic unit 104 is also configured to display an antenna directional guide 200, as shown in FIG. 2, on the video display 110 of the television 100 to inform the viewer of the directional locations of available broadcasting stations and determine the correct or desired direction of the antenna 122 to receive a desired broadcasting station. The antenna directional guide 200 can be accessed through a menu system of the logic unit 104 or via a dedicated key on the remote control unit 116.

Stored in the memory 106 of the television 100 is map information regarding broadcasting stations. The logic unit 104 is configured to display a map 210 corresponding to a viewer's location 214 defined by a zip code, street address, map coordinates, GPS location, and the like, and a table 220 having a first column 222 corresponding to a direction of the antenna and a second column 224 listing broadcast channels corresponding to broadcasting stations available along the reception direction, e.g., antenna directions A, B and C, of the antenna 122. The map 210 includes street or roadway representations 212 and a compass arrow 213 designating the north N direction. Upon accessing the antenna directional guide 200 a first time, the viewer is prompted to enter the viewer's geographical location.

In one embodiment, the antenna directions A, B, C and the like, can be predetermined directions determined by the logic unit 104 based on a viewer's location 214 and available broadcasting stations in the geographical area corresponding to the viewer's geographical location 214. The viewer is prompted to choose a antenna direction from the list of directions 222 in the table 220. Upon receipt of the selected direction, the logic unit 104 instructs the directional controller 124 of the antenna unit 120 to orient the antenna 122 in the desired direction.

In another embodiment, the viewer can step through antenna directions using the cursor on the remote control unit 116. The antenna directions through which the viewer steps correspond to degrees on a compass with north N being at 0° and 360°. The step increments can be in single or multiple degrees. As the viewer steps through antenna directions, the available broadcast channels corresponding to the antenna direction are determined by the logic unit 104 and displayed to the viewer on the video display. Upon receipt of the selected direction, the logic unit 104 instructs the directional controller 124 of the antenna unit 120 to orient the antenna 122 in the desired direction.

When the viewer selects a preferred antenna direction, the selected direction and corresponding available broadcast channels are stored in memory 106. When the viewer accesses the antenna directional guide 200, the save antenna directions can be displayed in the antenna direction table 220. The viewer can then be prompted to choose a saved antenna direction in the table 220 or find a new antenna direction by stepping the through antenna directions using the cursor on the remote control unit 116.

The particular examples set forth herein are instructional and should not be interpreted as limitations on the applications to which those of ordinary skill are able to apply the systems and methods described herein. Modifications and other uses are available to those skilled in the art which are encompassed within the spirit of the invention as defined by the scope of the appended claims.

What is claimed is:

1. A television system comprising
an antenna unit including an antenna and a antenna direction controller coupled to the antenna, wherein digital broadcast signals are receivable by the antenna, and
a television coupled to the antenna unit, the television including a central processing unit coupled to an audio-video output unit, the central processing unit being configured to determine directional locations of available broadcasting stations corresponding to a viewer's location from directional location data stored in memory of the central processing unit, display an antenna directional guide on a display screen of the audio-video output unit, and instruct the directional controller to orient the antenna in corresponding to a selected antenna direction.

2. The television system of claim 1 wherein the central procession unit is configured to prompt a viewer to enter location information identifying the viewer's geographic location.

3. The television system of claim 2 wherein the location information includes one or more of a zipcode, street address, map coordinates or GPS location.

4. The television system of claim 1 wherein the central procession unit is configured to prompt a viewer to select an antenna direction from the antenna direction guide.

5. The television system of claim 1 wherein the antenna direction guide includes map information regarding broadcasting station locations corresponding to a viewer's location.

6. The television system of claim 5 wherein the antenna direction guide includes a list of antenna reception directions and for each antenna reception direction a list of broadcast channels corresponding to broadcasting stations available along the antenna reception direction.

7. The television system of claim 5 wherein the central procession unit is configured to prompt a viewer to enter an antenna reception direction and for each antenna reception direction entered display a list of broadcast channels corresponding to broadcasting stations available along the entered antenna reception direction.

8. The television system of claim 1 wherein the central procession unit includes a logic unit coupled to the memory, wherein the logic unit includes integrated, processors, and software stored in memory and executable on the processors.

9. The television system of claim 1 wherein the audio-video output unit includes a speaker.

10. The television system of claim 1 further comprising a remote control unit operably coupled to a remote signal receiver coupled to the central processing unit.

11. The television system of claim 8 wherein the logic unit includes a menu system displayable on the display screen.

12. A method for orienting an antenna of an antenna unit coupled to television at an antenna reception direction to receive digital broadcast signals, comprising the steps of
displaying an antenna directional guide on a display screen of a television, the antenna directional guide including directional location information of available broadcasting stations stored in memory of the television and corresponding to a viewer's location,
prompting a viewer to select an antenna reception direction, and
instructing a directional controller of an antenna unit coupled to the television to orient an antenna coupled to the directional controller at the selected antenna reception direction.

13. The method of claim 12 further comprising the step of determining directional locations of available broadcasting stations corresponding to a viewer's location from directional location data stored in memory of the television.

14. The method of claim 13 further comprising the step of prompting a viewer to enter location information corresponding to the viewer's geographic location.

15. The method of claim 14 wherein the location information includes one or more of a zipcode, street address, map coordinates or GPS location.

16. The method of claim 12 wherein the antenna direction guide includes map information regarding broadcasting station locations corresponding to a viewer's location.

17. The method of claim 16 wherein the antenna direction guide includes a list of antenna reception directions and, for each antenna reception direction, a list of broadcast channels corresponding to broadcasting stations available along the antenna reception direction.

18. The method of claim 16 further comprising the step of prompting a viewer to enter an antenna reception direction and, for each antenna reception direction entered, display a list of broadcast channels corresponding to broadcasting stations available along the entered antenna reception direction.
